(19) United States
(12) Patent Application Publication
(10) Pub. No.: US 2013/0284208 A1
(43) Pub. Date: Oct. 31, 2013

(54) METHOD AND APPARATUS FOR LIQUID TREATMENT OF WAFER-SHAPED ARTICLES

(71) Applicants: Philipp ZAGORZ, VILLACH (AT); Michael GANSTER, ST. STEFAN (AT); Alois GOLLER, VILLACH (AT)

(72) Inventors: Philipp ZAGORZ, VILLACH (AT); Michael GANSTER, ST. STEFAN (AT); Alois GOLLER, VILLACH (AT)

(73) Assignee: LAM RESEARCH AG, VILLACH (AT)

(21) Appl. No.: 13/455,406

(22) Filed: Apr. 25, 2012

(51) Int. Cl. B08B 3/08; E03B 1/00

(52) U.S. Cl. 134/18; 137/613

(57) ABSTRACT

An in-line mixing system provides a process liquid for treatment of wafer-shaped articles. The system comprises a first flow regulator configured to regulate flow of a first liquid stream, a second flow regulator configured to regulate flow of a second liquid stream having a chemical component, a refractive index meter configured to provide a refractive index measurement of a mixture of the first and second liquid streams, a combined flow meter configured to provide a combined flow measurement of the mixture of the first and second liquid streams, and an automatic controller. The automatic controller is configured to operate the first and second flow regulators based upon the refractive index measurement and the combined flow measurement.

### BACKGROUND OF THE INVENTION

1. Field of the Invention

The invention relates generally to methods and apparatus for liquid treatment of wafer-shaped articles, such as semiconductor wafers, wherein one or more process liquids are dispensed onto a surface of the wafer-shaped article.

2. Description of Related Art

Semiconductor wafers are subjected to various liquid treatment processes such as etching, cleaning, polishing, drying and material deposition. To accommodate such processes, a single wafer may be supported in relation to one or more process liquid nozzles by a chuck associated with a rotatable carrier, as is described for example in U.S. Pat. Nos. 4,903,717 and 5,513,668.

Alternatively, a chuck in the form of a ring rotor adapted to support a wafer may be located within a closed process chamber and driven without physical contact through an active magnetic bearing, as is described for example in International Publication No. WO 2007/101764 and U.S. Pat. No. 6,485,531. Other known structures, including rotating and non-rotating supports, can be used for supporting a wafer-shaped article in the course of a liquid treatment process.

Process liquids can be dispensed onto one or both major surfaces of the semiconductor wafer, optionally as the wafer is rotated. Such process liquids include, for example, deionized (DI) water and various chemical components at a predetermined concentration in DI water. Suitable chemical components include, for example, hydrofluoric acid (HF), sulfuric acid, hydrochloric acid, ammonium hydroxide and isopropyl alcohol.

A predetermined concentration of a chemical component may be established by combining DI water and the chemical component in a fixed ratio in a tank mixing system before delivering the resulting process liquid to a wafer-shaped article. However, tank mixing systems are batch processes and generally are large, expensive and not suitable for quickly changing process fluid concentrations, especially during the course of a surface treatment process.

In-line or “point of use” (POU) mixing may be accomplished by combining a DI water stream with a given chemical component stream at predetermined respective flow rates. Where the concentration of the chemical component stream is fixed and known, the concentration of the combined process liquid stream after mixing can be determined based upon the respective flow rates of the individual DI water and chemical component streams. Flow meters located in each of the individual streams upstream of the point of mixing may be used for that purpose. However, flow meters provide only an indirect measure of the expected process fluid concentration and assume that the concentration of the incoming chemical component stream is stable. Changing downstream concentration based solely upon flow measurements of the incoming streams generally is slow and inaccurate where a large range of process liquid concentrations are utilized.

### SUMMARY OF THE INVENTION

The present inventors have developed improved processes and apparatus for providing a process liquid for surface treatment of wafer-shaped articles, in which the refractive index and flow rate of the process liquid stream are used to regulate flow rates of the individual water and chemical component streams. Consequently, the process liquid delivered to a wafer-shaped article can be modified on-demand to correct for unintended deviations of flow and concentration, and to alter the process liquid flow rate and/or concentration with respect to time according to any desired profile. Such changes to the process liquid stream can be conducted between liquid treatment stages or during the course of a given treatment.

Thus, the invention in one aspect relates to an in-line mixing system for use in providing a process liquid for treatment of wafer-shaped articles, comprising a first flow regulator configured to regulate flow of a first liquid stream, a second flow regulator configured to regulate flow of a second liquid stream having a chemical component, a refractive index meter configured to provide a refractive index measurement of a mixture of the first and second liquid streams, a combined flow meter configured to provide a combined flow measurement of the mixture of the first and second liquid streams, and an automatic controller configured to operate the first and second flow regulators based upon the refractive index measurement and the combined flow measurement.

In preferred embodiments of the in-line mixing system according to the present invention, the automatic controller is configured to adjust the first and/or second flow regulator based upon the refractive index measurement so as to selectively provide an adjusted mixing ratio of the first and second liquid streams without significantly changing a combined flow rate of the mixture of the first and second liquid streams.

In preferred embodiments of the in-line mixing system according to the present invention, the automatic controller is configured to adjust the first and second flow regulators based upon the combined flow measurement so as to selectively provide an adjusted flow of the first and second liquid streams without significantly changing a mixing ratio of the first and second liquid streams.

In preferred embodiments of the in-line mixing system according to the present invention, the automatic controller is configured to generate a combined output signal based upon the combined flow measurement and the refractive index measurement, and to operate the first or the second flow regulator based upon the combined output signal.

In preferred embodiments, the in-line mixing system according to the present invention further comprises a first automatic on/off valve configured to open and close flow of the first liquid stream, a second automatic on/off valve configured to open and close flow of the second liquid stream, and the automatic controller is configured to operate the first and second automatic valves based upon the refractive index measurement.

In another aspect, the present invention provides an apparatus for use in liquid treatment of wafer-shaped articles, comprising a support for holding a wafer-shaped article in a predetermined orientation, a process liquid delivery system having a first flow path for conducting a first liquid stream comprising water, a second flow path for conducting a second liquid stream comprising a chemical component, a third flow path fluidly connected to the first and second flow paths to conduct a mixture of the first and second liquid streams to the support, and an in-line mixing system comprising a first flow regulator configured to regulate flow of the first liquid stream, a second flow regulator configured to regulate flow of the second liquid stream, a refractive index meter configured to provide a refractive index measurement of the mixture of the first and second liquid streams, a combined flow meter configured to provide a combined flow measurement of the mixture of the first and second liquid streams, and an automatic controller configured to adjust the first and second flow regulators based upon the refractive index measurement and the combined flow measurement.

In preferred embodiments of the apparatus according to the present invention, a temperature measuring device is operatively connected with the third flow path, wherein the refractive index measurement is temperature-compensated.

In preferred embodiments of the apparatus according to the present invention, the automatic controller is configured to adjust the first and second flow regulators based upon the refractive index measurement through a first control loop, and based upon the combined flow measurement through a second control loop.

In preferred embodiments of the apparatus according to the present invention, the first control loop operates faster than the second control loop.

In preferred embodiments, the apparatus according to the present invention also comprises an automatic on/off valve in each of the first and second fluid paths, wherein the automatic controller is configured to operate the first and second automatic valves so as to selectively change the concentration of the process fluid.

In another aspect, the present invention provides a method for liquid treatment of wafer-shaped articles, comprising positioning a wafer-shaped article on a support in a predetermined orientation, conducting a first liquid stream comprising water, conducting a second liquid stream comprising a chemical component, mixing the first and second liquid streams to provide a process liquid stream, determining the refractive index and flow rate of the process liquid stream, delivering the process liquid stream to the wafer-shaped article, and regulating the concentration or flow rate of the process liquid stream by adjusting the flow of the first and/or the second liquid stream based upon the refractive index and flow rate of the process fluid stream.

In preferred embodiments of the methods according to the present invention, the step of regulating comprises changing the concentration of the process fluid stream during a liquid treatment process.

In preferred embodiments of the methods according to the present invention, the step of regulating comprises changing the flow rate of the process fluid stream during a liquid treatment process.

In preferred embodiments of the methods according to the present invention, the step of regulating comprises operating a flow regulator located in each of the first and second liquid streams in response to a control signal generated by combining signals corresponding to the refractive index and the flow rate of the process liquid stream.

In preferred embodiments of the methods according to the present invention, the step of regulating further comprises operating an automatic on/of valve located in each of the first and second liquid streams in response to a control signal corresponding to the refractive index of the process liquid stream.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is a schematic diagram of a first embodiment of the apparatus and in-line mixing systems according to the present invention; and

FIG. 2 is a schematic diagram of an example of a mixing profile which can be obtained with the present invention.

### DETAILED DESCRIPTION OF PREFERRED EMBODIMENTS

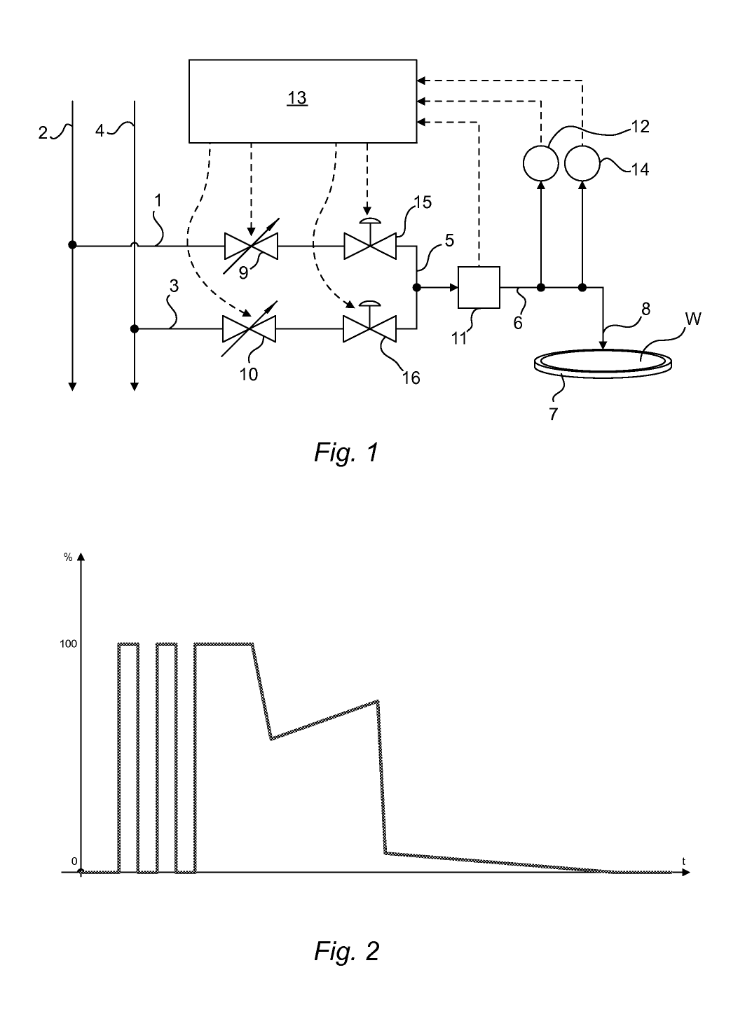

Referring now to FIG. 1, shown therein is an apparatus for liquid treatment of wafer-shaped articles comprising a point-of-use in-line mixing system according to a first embodiment of the invention.

A first flow path (1) conducts a first liquid stream comprising water, preferably deionized (DI) water, from a water source (2). The water source (2) may be a pressurized stream, a storage tank or any other suitable source. A second flow path (3) conducts a second liquid stream comprising a chemical component, such as HF or any other chemical component useful for performing liquid treatment of a wafer-shaped article, from a chemical component source (4). Chemical source (4) also may be a pressurized stream, a storage tank or any other suitable source. The second liquid stream provides the chemical component at a predetermined concentration, preferably in water, more preferably in DI water.

A point of mixing (5) is provided at a location along the length of the first liquid path (1) and second liquid path (3) at which the first and second liquid paths are combined. Thus, the point of mixing combines the first and second liquid streams to form a process liquid stream for treatment of a wafer-shaped article. The point of mixing (5) may comprise any structure suitable for combining the first and second liquid paths, including, without limitation, a t-joint, static mixer, and the like.

A third liquid path (6), fluidly connected to the point of mixing, conducts the process liquid stream from the point of mixing to a semiconductor wafer (w), which is typically supported by a rotatable chuck (7) with the axis of the wafer and the coincident rotational axis of the chuck oriented vertically or within a few degrees on either side of vertical. Chuck (7) is preferably a spin chuck for single wafer wet processing, and may be constructed for example as described in U.S. Pat. Nos. 4,903,717 and 5,513,668.

Chuck (7) may alternatively be constructed as described in commonly-owned U.S. Patent Application Pub. No. 2011/0253181 (corresponding to WO 2010/113089), in which case it will be appreciated that the wafer W will be suspended and depend downwardly from the magnetic rotor that constitutes the rotary part of the chuck.

The arrow 8 represents a liquid dispensing nozzle. Although nozzle 8 in FIG. 1 is positioned above the wafer W so as to dispense liquid onto the upwardly-facing surface of wafer W, those skilled in the art will recognize that nozzle 8 could instead be provided beneath the wafer W so as to dispense process liquid onto the downwardly-facing surface of wafer W, or that liquid dispensing nozzles may be provided on both sides of wafer W. Moreover, plural nozzles may be provided on either or both sides of the wafer W.

As will be apparent to those skilled in the art based on the foregoing description, a process liquid stream conducted by the third fluid path (6) will exhibit a flow rate which is proportional to the combined flow rates of the first and second liquid streams, and a chemical component concentration which can be determined based upon the respective concentrations and flow rates of the first and second liquid streams. That is, a defined change in the flow rate of either or both of the first and second liquid streams will produce a predictable change to the flow rate and concentration of the process liquid stream.

Automatic and selective control of the process liquid's flow and concentration are accomplished by the embodiment of the invention shown in FIG. 1 with a point-of-use in-line mixing system, as will now be described with further reference to FIG. 1.

A first flow regulator 9, such as a variably controlled fluid valve, is operatively located at a point along the first flow path (1) between the water source (2) and point of mixing (5). A second flow regulator 10 is similarly operatively located at a point along the second flow path 3 between the chemical source and the point of mixing. Flow regulators 9, 10 can be any automatically operated devices that, in response to a signal, preferably and electronic signal, increase or decrease liquid flow by a preset amount. Flow regulators 9, 10 may increase or decrease liquid flow incrementally, whereby the flow rate of the affected liquid stream is changed by a set number of increments in response to a given signal. Preferably, each flow regulator 9, 10 operates upon equivalently sized increments.

A combined flow meter 11 is operatively located at the point of mixing 5 or at a location along the third flow path 6 which is between the point of mixing 5 and the dispensing nozzle(s) 8. Combined flow meter 11 measures flow rate, or a relative change of flow rate, of the process liquid stream conducted in the third flow path 6. Combined flow meter 11 preferably is an electronic flow meter which generates an electronic signal that is representative of the process liquid stream flow rate, or a relative change in the process liquid stream flow rate. The combined flow meter 11 can generate the electronic signal continuously, periodically or at programmed intervals.

A refractive index meter 12, such as a refractometer, also is operatively located at the point of mixing 5 or at a location along the third flow path 6 which is between the point of mixing and the dispensing nozzle(s) 8. The refractive index meter measures refractive index, or a relative change of refractive index, of the process liquid stream conducted in the third flow path 6. Refractive index meter 12 preferably is an electronic refractometer which generates an electronic signal that is representative of the process liquid stream refractive index, or a relative change in the process liquid stream refractive index. The refractive index meter can generate the electronic signal continuously, periodically or at programmed intervals.

It will be appreciated that flow meters and refractive index meters which provide analog signals may also be provided.

A controller 13 is operatively associated with the refractive index meter 12, combined flow meter 11, and each flow regulator 9, 10. As is schematically depicted by dotted arrows in FIG. 1, controller 13 is configured to receive information, preferably signals, and more preferably electronic signals, from the refractive index meter 12 and the combined flow meter 11. Controller 13 is further configured to send information, preferably signals, and more preferably electronic signals, to flow regulator 9 and flow regulator 10.

Controller 13 processes an input signal generated by the refractive index meter to provide a responsive output signal for controlling flow regulator 9 and a responsive output signal for controlling flow regulator 10. Preferably, controller 13 processes refractive index signals pursuant to a first control loop. A temperature meter 14 is operatively associated with the third flow path so as to provide a temperature signal indicative of process liquid temperature. The temperature signal is utilized by the controller 13, or by the refractive index meter 12, in each case to facilitate temperature-compensation of the refractive index signal. Temperature measurement and compensation of the refractive index measurement also occur within the refractive index meter.

The temperature signal can also be utilized by the controller 13 for temperature regulation by spiking a heated liquid (e.g. heated DI water) in order to accurately control the temperature of the process liquid. Thereby two liquids of the same concentration however with unknown temperature (the first temperature of the first liquid above the desired temperature, the second temperature below the desired temperature) can be used for mixing and thus providing a mixture of a desired temperature. If two liquids of the same temperature are mixed this should preferably occur upstream of the spiking of the chemical component.

Controller 13 also processes an input signal generated by the combined flow meter to provide a responsive output signal for controlling flow regulator 9 and a responsive output signal for controlling flow regulator 10. Preferably, controller 13 processes combined flow signals pursuant to a second control loop. Typically, but not necessarily, the above-described first control loop will process information faster than the second control loop.

Accordingly, each of flow regulators 9, 10 is automatically controlled, by operation of the controller 13, in response to the refractive index and the flow rate of the process liquid stream. Concentration-based and flow-based controls are therefore accomplished.

For example, unintended deviations of process liquid concentration, which may arise from fluctuations of flow occurring at the water source, chemical component source, or the first and/or second flow path, or which may arise from unintended concentration changes occurring at, e.g., the chemical component source, can be indicated in-situ by the refractive index meter and corrected through responsive control of the first and/or second regulator valves via the first control loop. In such an instance, controller 13 may be configured to adjust each regulator valve 9,10 by a number of increments sufficient to correct the process liquid concentration deviation while maintaining the same process liquid flow rate. For example, regulator valve 9 may adjusted to increase flow by one increment whereas regulator valve 10 is adjusted to decrease flow by the same increment.

Also, unintended deviations of process liquid flow rate, which too may arise from fluctuations of flow occurring at the water source, chemical component source, or the first and/or second flow path, can be indicated in-situ by the combined flow meter and corrected through responsive control of the first and second regulator valves via the second control loop. In such an instance, controller 13 may be configured to adjust each regulator valve 9, 10 by a number of increments sufficient to correct the process liquid flow deviation while maintaining the same process liquid concentration.

Controller 13 in the preferred embodiment depicted in FIG. 1 also is configured such that it operates flow regulators 9, 10 to increase or decrease flow so as to provide a changed process liquid flow rate in response to a combined flow signal received from the combined flow meter and in conjunction with a desired, and preferably pre-programmed, liquid treatment protocol. Controller 13 in the depicted preferred embodiment also is configured such that, in response to a refractive index signal received from the refractive index meter and in conjunction with a desired, and preferably pre-programmed, liquid treatment protocol, flow regulators 9, 10 can be driven to increase or decrease flow so as to provide a changed process liquid concentration.

Preferably, controller 13 is further configured such that the first and second control loops are interconnected so as to generate a single control signal for the first flow regulator 1, and a single control signal for the second flow regulator 3, each control signal being responsive to both the combined flow rate and the refractive index of the process liquid stream. That is, controller 13 is configured to superimpose, add or otherwise combine the output of the first and second control loops such that each flow regulator receives a single control signal, the implementation of which provides the desired effect on both the flow rate and concentration of the process liquid stream.

Suitable processes and algorithms for combining the first and second control loops will be readily apparent to those skilled in the art in light of the description provided herein. By way of example, and without limitation, controller 13 may include a signal adder, whereby information generated pursuant to the first and second control loops is added.

For example, where a liquid treatment protocol calls for a stage in which the process liquid is delivered to a wafer-shaped article at a reduced concentration and a higher flow rate, controller 13 is configured to combine the information processed by the first and second control loops to generate two control signals, one for each flow regulator, sufficient to operate each flow regulator so as to accomplish the desired changes in process liquid flow and concentration substantially simultaneously.

By automatically controlling flow regulators 9, 10 based upon signals generated by both the combined flow meter 11 and refractive index meter 12, virtually any concentration and flow profile can be automatically provided. One such concentration and flow profile which is enabled by the present invention is provided in FIG. 2. As noted, a desired flow and concentration profile may be applied to affect different wafers, different treatment stages for a given wafer, or during the course of a liquid treatment stage.

In a further aspect of the preferred embodiment depicted in FIG. 1, a first automatic valve 15 and a second automatic valve 16 are operatively located along the first and second flow paths, respectively, between the water or chemical component source and the point of mixing. Typically, automatic valves 15, 16 are on/off valves which, preferably, are capable of being switched rapidly (preferably within less than about 200 ms) and frequently (preferably approximately every two seconds).

Controller 13 regulates the automatic valves 15, 16 in response to signals generated by the refractive index meter 12. Automatic valves 15, 16 are adapted to enable quick and/or intermittent changes in process liquid concentration. For example, by frequently opening and closing automatic valve 15 and/or automatic valve 16, and by varying the duration that each automatic valve is open and closed, process liquid flow and concentration can be quickly set over a wide range of concentrations. Of course, controller 13 can be configured to close automatic valve 16 at predetermined times to quickly change the process liquid stream from a chemical composition to essentially pure deionized water.

An example of the operation of the apparatus of FIG. 1 will now be described.

A semiconductor wafer W is positioned relative to chuck 7 and rotated. A DI water stream is conducted via flow path 1 at a flow rate governed by flow regulator 9. Concurrently, a chemical component stream comprising HF at a given concentration is conducted via flow path 3 at a flow rate governed by flow regulator 10. Each of the automatic valves 15 and 16 is open.

The DI water stream and chemical component stream are combined and mixed to provide a process liquid stream containing HF at a predetermined concentration, which process liquid stream is delivered to spray nozzles oriented to deliver the process liquid stream to a surface of the semiconductor wafer W.

The refractive index of the process liquid stream is indicated by a signal generated by the refractive index meter 12 and sent to controller 13. Concurrently, the flow rate of the process liquid stream is indicated by a signal generated by the combined flow meter 11 and sent to controller 13.

At a predetermined time, and based upon combined information processed via the first and second control loops, controller 13 operates flow regulator 9 to decrease flow by one increment and operates flow regulator 10 to increase flow by one increment, so as to modify the process liquid stream to have a predetermined higher HF concentration without altering its flow rate.

What is claimed is:

1. An apparatus for use in providing a process liquid for treatment of wafer-shaped articles comprising:
a first flow regulator configured to regulate flow of a first liquid stream,
a second flow regulator configured to regulate flow of a second liquid stream having a chemical component,
a refractive index meter configured to provide a refractive index measurement of a mixture of said first and second liquid streams,
a combined flow meter configured to provide a combined flow measurement of said mixture of said first and second liquid streams, and
an automatic controller, wherein said automatic controller is configured to operate said first and second flow regulators based upon said refractive index measurement and said combined flow measurement.

2. An apparatus according to claim 1, wherein said automatic controller is configured to adjust said first and/or said second flow regulator based upon said refractive index measurement so as to selectively provide an adjusted mixing ratio of said first and second liquid streams without significantly changing a combined flow rate of said mixture of said first and second liquid streams.

3. An apparatus according to claim 1, wherein said automatic controller is configured to adjust said first and second flow regulators based upon said combined flow measurement so as to selectively provide an adjusted flow of said first and second liquid streams without significantly changing a mixing ratio of said first and second liquid streams.

4. An apparatus according to claim 1, wherein said automatic controller is configured to generate a combined output signal based upon said combined flow measurement and said refractive index measurement, and to operate said first or said second flow regulator based upon said combined output signal.

5. An apparatus according to claim 1, further comprising a first automatic on/off valve configured to open and close flow of said first liquid stream, a second automatic on/off valve configured to open and close flow of said second liquid stream, wherein said automatic controller is configured to operate said first and second automatic valves based upon said refractive index measurement.

6. An apparatus according to claim 1, further comprising a process liquid delivery system, said liquid delivery system comprising a first flow path for conducting said first liquid stream comprising water, a second flow path for conducting said second liquid stream comprising a chemical component, and a third flow path fluidly connected to said first and second flow paths to deliver a mixture of said first and second liquid streams.

7. An apparatus according to claim 6, further comprising a temperature measuring device operatively connected with said third flow path, wherein said refractive index measurement is temperature-compensated.

8. An apparatus according to claim 6, wherein said automatic controller is configured to adjust said first and said second flow regulators based upon said refractive index measurement through a first control loop, and based upon said combined flow measurement through a second control loop, wherein said first control loop operates faster than said second control loop.

9. An apparatus according to claim 1, further comprising a temperature measuring device configured to provide a temperature measurement of said mixture of said first and second liquid streams, wherein said controller is configured to regulate flow of a heated liquid in response to said temperature measurement so as to regulate a temperature of said mixture of said first and second liquid streams.

10. An apparatus according to claim 6, further comprising:
a support for holding a wafer-shaped article in a predetermined orientation; wherein said third flow path conducts the mixture to said support.

11. A method for liquid treatment of wafer-shaped articles, comprising positioning a wafer-shaped article on a support in a predetermined orientation, conducting a first liquid stream comprising water, conducting a second liquid stream comprising a chemical component, mixing said first and second liquid streams to provide a process liquid stream, determining the refractive index and flow rate of said process liquid stream, delivering said process liquid stream to said wafer-shaped article, and regulating the concentration or flow rate of said process liquid stream by adjusting the flow of said first and/or said second liquid stream based upon said refractive index and flow rate of said process fluid stream.

12. The method according to claim 11, wherein said step of regulating comprises changing the concentration of the process fluid stream during a liquid treatment process.

13. The method according to claim 11, wherein said step of regulating comprises changing the flow rate of the process fluid stream during a liquid treatment process.

14. The method according to claim 11, wherein said step of regulating comprises operating a flow regulator located in each of said first and second liquid streams in response to a control signal generated by combining signals corresponding to said refractive index and said flow rate of the process liquid stream.

15. The method of claim 14, wherein said step of regulating further comprises operating an automatic on/of valve located in each of said first and second liquid streams in response to a control signal corresponding to said refractive index of the process liquid stream.
